(19) United States
(12) Patent Application Publication
(10) Pub. No.: US 2015/0172115 A1
(43) Pub. Date: Jun. 18, 2015

(54) MAPPING VIRTUAL NETWORK ELEMENTS TO PHYSICAL RESOURCES IN A TELCO CLOUD ENVIRONMENT

(71) Applicants: Kim Khoa Nguyen, Montreal (CA); Mohamed Cheriet, Montreal (CA); Yves Lemieux, Kirkland (CA)

(72) Inventors: Kim Khoa Nguyen, Montreal (CA); Mohamed Cheriet, Montreal (CA); Yves Lemieux, Kirkland (CA)

(73) Assignee: TELEFONAKTIEBOLAGET L M ERICSSON (PUBL), Stockholm (SE)

(21) Appl. No.: 14/133,099

(22) Filed: Dec. 18, 2013

(51) Int. Cl. H04L 12/24; H04L 29/08

(52) U.S. Cl. CPC H04L 41/0806; H04L 67/10

(57) ABSTRACT

Systems and methods for assigning virtualized network elements to physical resources in a cloud computing environment are provided. A resource request is received as input indicating a required number of virtual machines and a set of virtual flows, each of the virtual flows indicating a connection between two virtual machines which need to communicate with one another. Each of the requested virtual machines is assigned to a physical server. The set of virtual flows can be modified to remove any virtual flow connecting virtual machines which have been assigned to the same physical server. Each of the virtual flows in the modified set is assigned to a physical link. If a bandwidth capacity of a requested virtual flow is greater than the available bandwidth of a single physical link between servers, multiple links can be allocated to the virtual flow.

### TECHNICAL FIELD

This disclosure relates generally to systems and methods for mapping virtualized network elements to physical resources in a data center.

### BACKGROUND

Cloud computing has become a rapid growing industry that plays a crucial role in the Information and Communications Technology (ICT) sector. Modern data centers deploy virtualization techniques to increase operational efficiency and enable dynamic resource provisioning in response to changing application needs. A cloud computing environment provides computation, capacity, networking, and storage on-demand, typically through virtual networks and/or virtual machines (VMs). Multiple VMs can be hosted by a single physical server, thus increasing utilization rate and energy efficiency of cloud computing services. Cloud service customers may lease virtual compute, network, and storage resources distributed among one or more physical infrastructure resources in data centers.

A Telco Cloud is an example of a cloud environment hosting telecommunications applications, such as IP Multimedia Subsystem (IMS), Push To Talk (PTT), Internet Protocol Television (IPTV), etc. A Telco Cloud often has a set of unique requirements in terms of Quality of Service (QoS), availability and reliability. While conventional Internet-based cloud hosting systems, like Google, Amazon and Microsoft are server-centric, a Telco Cloud is more network-centric. It contains many networking devices and its networking architecture is often complex with various layers and protocols. The Telco Cloud infrastructure provider may allow multiple Virtual Telecom Operators (VTOs) sharing, purchasing or renting physical network and compute resources of the Telco Cloud to provide telecommunications services to end-users. This business model allows the VTOs to provide their services without having the costs and issues associated with owning the physical infrastructure.

Conventional networking systems utilize a distributed control plane that requires each device and every interface to be managed independently, device by device. They also have a complex array of network protocols. Such architecture is not scalable to efficiently operate in a Cloud, which can contain huge numbers of attached devices, isolated independent subnetworks, multi-tenancy, and VMs. From a broader perspective, in order to support a larger base of consumers from around the world, infrastructure providers have recently established data centers in multiple geographical locations to equally distribute loads, provide redundancy and ensure reliability in case of site failures.

These trends suggest a different approach to the network architecture, in which the control plane logic is handled by a centralized server and the forwarding plane consists of simplified switching elements “programmed” by the centralized controller. Software Defined Networking (SDN) is a new paradigm in network architecture that introduces programmability, centralized intelligence and abstractions from the underlying network infrastructure. A network administrator can configure how a network element behaves based on data flows that can be defined across different layers of network protocols. SDN separates the intelligence needed for controlling individual network devices (e.g., routers and switches) and offloads the control mechanism to a remote controller device (often a stand-alone server or end device). An SDN approach provides complete control and flexibility in managing data flow in the network while increasing scalability and efficiency in the Cloud.

In the context of cloud computing, a “virtual slice” is composed of a number of VMs linked by dedicated flows. This definition addresses both computing and network resources involved in a slice, providing end users with the means to program, manage, and control their cloud services in a flexible way. The issue of creating virtual slices in a data center has not been completely resolved prior to the introduction of SDN mechanisms. SDN implementations to date have made use of centralized or distributed controllers to achieve architecture isolation between different customers, but without addressing the issues surrounding optimal VM location placement, optimal virtual flow mapping, and flow aggregation.

Therefore, it would be desirable to provide a system and method that obviate or mitigate the above described problems.

### SUMMARY

It is an object of the present invention to obviate or mitigate at least one disadvantage of the prior art.

In a first aspect of the present invention, there is provided a method for assigning virtual network elements to physical resources. The method comprises the steps of receiving a resource request including a plurality of virtual machines and a set of virtual flows, each of the virtual flows connecting two virtual machines in the plurality. Each virtual machine in the plurality of virtual machines is assigned to a physical server in a plurality of physical servers in accordance with at least one allocation criteria. The set of virtual flows is modified to remove a virtual flow connecting two virtual machines assigned to a single physical server. Each of the virtual flows in the modified set is assigned to a physical link.

In an embodiment of the first aspect, the allocation can criteria include maximizing a consolidation of virtual machines into physical servers. The allocation criteria can optionally include minimizing a number of virtual flows required to be assigned to physical links. The allocation criteria can further optionally include comparing a processing requirement associated with at least one of the plurality of virtual machines to an available processing capacity of at least one of the plurality of physical servers.

In another embodiment of the first aspect, the step of assigning each virtual machine in the plurality of virtual machines to a physical server in the plurality of physical servers includes sorting the physical servers in decreasing order according to server processing capacity. A first one of the physical servers can be selected in accordance with the sorted order of physical servers. In some embodiments, the virtual machines can be sorted in increasing order according to virtual machine processing requirement. A first one of the virtual machines can be selected in accordance with the sorted order of virtual machines. The selected virtual machine can then be placed on, or assigned to, the selected physical server. In some embodiments, responsive to determining that a processing requirement of the selected virtual machine is greater than an available processing capacity of the selected physical server, a second of the physical servers can be selected in accordance with the sorted order of physical servers; and the selected virtual machine can be placed on the second physical server.

In another embodiment, the removed virtual flow is assigned an entry in a forwarding table in the single physical server.

In another embodiment, responsive to determining that a bandwidth capacity of a virtual flow is greater than an available bandwidth capacity of a physical link, the virtual flow is assigned to multiple physical links. The multiple physical links can be allocated in accordance with a source physical server, a destination physical server, and the bandwidth capacity associated with the virtual flow.

In a second aspect of the present invention, there is provided a cloud management device comprising a communication interface, a processor, and a memory, the memory containing instructions executable by the processor. The cloud management device is operative to receive a resource request, at the communication interface, including a plurality of virtual machines and a set of virtual flows, each of the virtual flows connecting two virtual machines in the plurality. Each virtual machine in the plurality of virtual machines is assigned to a physical server in a plurality of physical servers in accordance with an allocation criteria. The set of virtual flows is modified to remove a virtual flow connecting two virtual machines assigned to a single physical server. Each of the virtual flows in the modified set is assigned to a physical link.

In an embodiment of the second aspect, the cloud management device can transmit, at the communication interface, a mapping of the virtual machines and the virtual flows to their assigned physical resources.

In another aspect of the present invention, there is a provided a data center manager comprising a computer manager module, a network controller module and a resource planner module. The compute manager module is configured for monitoring server capacity of a plurality of physical servers. The network controller module is configured for monitoring bandwidth capacity of a plurality of physical links interconnecting the plurality of physical servers. The resource planner module is configured for receiving a resource request indicating a plurality of virtual machines and a set of virtual flows; for instructing the compute manager module to instantiate each virtual machine in the plurality of virtual machines to a physical server in the plurality of physical servers in accordance with an allocation criteria; for modifying the set of virtual flows to remove a virtual flow connecting two virtual machines assigned to a single physical server; and for instructing the network controller module to assign each of the virtual flows in the modified set to a physical link in the plurality of physical links.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates an example of assigning virtual resources to the underlying physical infrastructure;

FIG. 2 illustrates an example blade system;

FIG. 3 illustrates a Data Center Manager device;

FIG. 4 illustrates an example method for allocating virtual resources;

FIG. 5 illustrates an example method for server consolidation;

FIG. 6 illustrates an example method for flow assignment;

FIG. 7 illustrates a method according to an embodiment of the present invention; and

FIG. 8 illustrates an apparatus according to an embodiment of the present invention.

### DETAILED DESCRIPTION

The present disclosure is directed to systems and methods for improving the process of resource allocation, both in terms of processing and networking resources, in a cloud computing environment. Based on SDN and cloud network planning technologies, embodiments of the present invention can optimize resource allocations with respect to power consumption and greenhouse gas emissions while taking into account Telco cloud application requirements.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

Along with the widespread utilization of virtual networks and VMs in data centers or networks of geographically distributed data centers, a fundamental question for cloud operators is how to allocate/relocate a large number of virtual network slices with significant aggregate bandwidth requirements while maximizing the utilization ratio of their infrastructure. A direct result of an efficient resource allocation solution is to minimize the number of idle servers and unused network links, thus optimizing the power consumption and greenhouse gas emissions of data centers.

In addition to the scalability in terms of the number of resources, a key challenge of the overall resource planning problem is to develop a component which is able to efficiently interact with the existing cloud management modules to collect information and to send commands to achieve the desired resource allocation plan. This process is preferably performed automatically, in a short interval of time, with respect to a large number of cloud customers. An efficient method for mapping virtual resources can help cloud operators increase their revenue while reducing resource and power consumption.

Embodiments of the present invention provide methods for allocating both processing and networking resources for user requests, regarding constraints of infrastructure, the quality of service, and architecture of underlying infrastructure, as well as unique features of cloud computing environment such as resource consolidation and multipath connection.

Conventional solutions in the area of resource allocation in data centers only partially consider optimizing VM locations, virtual flow mapping and flow aggregation. Existing solutions have failed to address the problems associated with combining mapping and consolidation. Additionally, the concept of multipath forwarding has not been considered. Conventional IP routing schemes have been aimed at the “fastest path”, “shortest path” or “best route”. Server consolidation is a substantial factor in achieving energy efficiency in cloud computing, and multipath forwarding is a key element for increasing scalability data center network.

Embodiments of the present invention will be discussed with respect to a Telco Cloud, though it will be appreciated by those skilled in the art that these may be implemented in any variety of data centers and network of data centers including, but not limited to public cloud, private cloud and hybrid cloud.

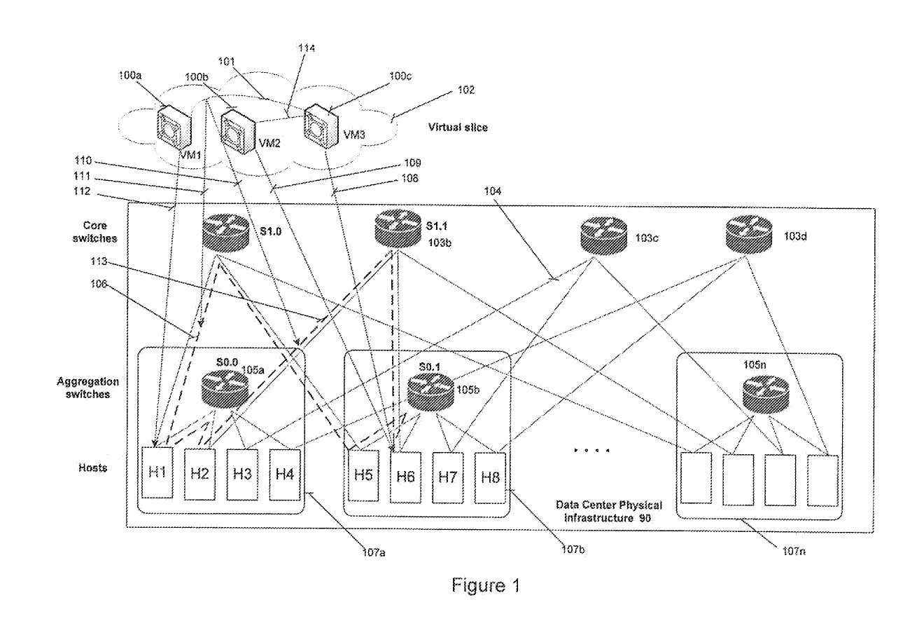

FIG. 1 illustrates an overview of assigning an example virtual slice 102 into the underlying physical infrastructure of a data center 90. The physical data center 90 is connected using B-cube architecture which features multiple links between any pair of physical servers in the data center. In data center 90, a number of sub-racks (or rack shelves) 107a-107n are shown, each having four hosts (or server blades) and an aggregation switch 105a-105n. There are four core switches 103a-103d connected to the aggregation switches 105a-105n. Each host is logically linked to an aggregation switch and a core switch. For example, host H1 in sub-rack 107a is linked to aggregation switch 105a and core switch 103a. The bandwidth capacity of each logical link in the example of FIG. 1 is 1 Gbps. For example, link 106 is a 1 Gbps connection between switch 103a and host H1.

The example virtual slice 102, as can be specified and requested by a user, includes three VMs 100a-100c (each requiring 2 CPUs processing power) and two virtual flows 101a and 101b (each having a bandwidth capacity of 2 Gbps). The virtual flows 101a and 101b represent communication links that are required between the requested VMs. Virtual flow 101a is shown linking VM 100a to VM 100c and virtual flow 101b links VMs 100b and 100c.

FIG. 1 illustrates a set of “mappings” 108-112 between the virtual elements of the virtual slice 102 and the physical resources of the data center 90. Mapping 112 shows VM 100a mapping to host H1. Mapping 109 shows VM 100b mapping to host H6. Mapping 108 shows VM 100c also mapping to host H6. Virtual flow 101a maps to a path composed of two physical links—link 106 (H1-S1.0-H5-S0.1-H6) and link 113 (H1-S0.0-H2-S1.1-H6). Virtual flow 101b which links VMs 100b and 100c does not need to be mapped to a physical link(s) because the two VMs 100b and 100c are co-located in host H6. With this VM consolidation in host H6, communications between VM 100b and VM 100c do not consume any physical network bandwidth.

It should be noted that in the example of FIG. 1, the user request includes a request for a virtual flow with a bandwidth capacity greater than the available capacity of a single physical link (e.g. 2 Gbps for a virtual flow versus 1 Gbps for every physical link in data center 90). This demand can be afforded by a multipathing scheme in which the virtual flow will be routed on two separate physical paths. Such a scheme is not available in a best-route forwarding network, such as the Internet, in which only a single route is chosen for carrying data between a given pair of servers.

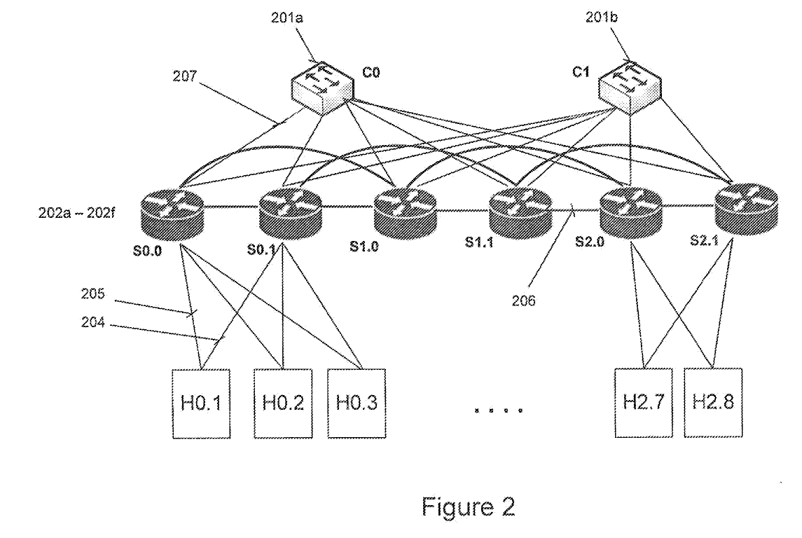

FIG. 2 illustrates the physical components of an example blade system which is a building block of a Telco Cloud solution as discussed herein. The blade system of FIG. 2 comprises two core switches 201a-201b, six aggregation switches 202a-202f, and 28 servers H0.1-H2.8. Each server is connected to a pair of aggregation switches by two 1 Gbps links. For example, server H0.1 is connected to switch S0.0 (202a) via 1 Gbps link 205 and to switch S0.1 (202b) via 1 Gbps link 204. Eight servers H0.1 to H0.8 are connected to switches S0.0 and S0.1. Eight servers H1.1 to H1.8 are connected to switches S1.0 (202c) and S1.1 (202d). Eight servers H2.1 to H2.8 are connected to switches S2.0 (202e) and S2.1 (202f). The aggregation switches are linked to each other by 10 Gbps links. For example, 10 Gbps link 206 is shown connecting switches S1.1 (202d) and S2.0 (202e). Each aggregation switch is connected to two core switches by two 1 Gbps links. For example, link 207 connects core switch C0 (201a) and aggregate switch S0.0 (202a). Such physical connections enables multipath forwarding scheme between each pair of servers.

Telecommunication applications are often composed of multiple components with a high degree of interdependence between these components. For example, an IP Multimedia Subsystem (IMS) involves Call Session Control Function (CSPF) proxies, Home Subscriber Server (HSS) databases, and several gateways. Continuous interactions among these components are established to provide end-to-end services to users, such as peer messaging, voice, and video streaming. When such an IMS system is deployed in a virtualized data center, a set of VMs and flows between those VMs (defined as a virtual slice) is required.

The Telco Cloud is managed and controlled by a middleware providing networking and computing functions, such as virtual network definition, VM creation, and removal. For example, OpenStack can be deployed to control the Telco Cloud.

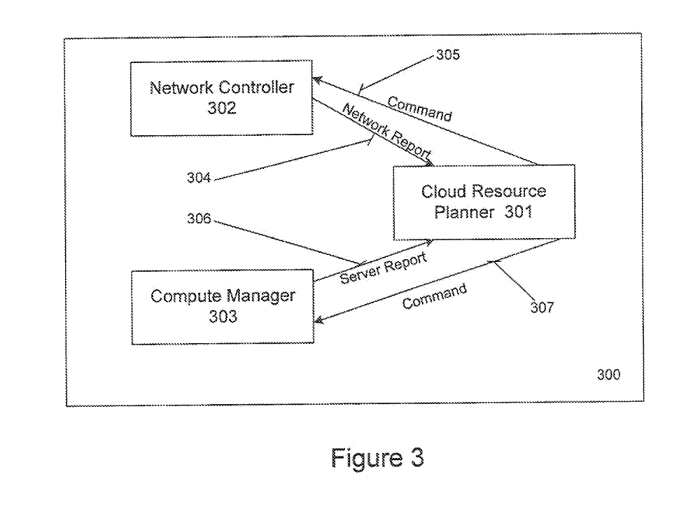

FIG. 3 illustrates an exemplary sequence of the interactions of a Cloud Resource Planner module 301, a Network Controller module 302 and a Compute Manager module 303 in a data center. Those skilled in the art will appreciate that, although these are shown as separate entities in FIG. 3, the modules can be functional entities within a Data Center Manager device 300. The Network Controller 302 is an entity which provides network configuration and monitoring functions. It is able to report bandwidth capacity of a link, as well as to define a virtual flow on a physical link. The Network Controller 302 can also turn off, or deactivate, a link to save power consumption. A deactivated link can later be reactivated. An OpenFlow Controller software, such as NOX, is an example of an implementation of the Network Controller 302. The Compute Manager 303 is an entity which provides server configuration and monitoring functions. It is able to report capacity of a server, such as the number of CPUs, memory capacity and input/output capacity. It can also deploy virtual machines on a server as well. OpenStack Nova software is an example of an implementation of the Compute Manager 303.

A Cloud Resource Planner module 301 is a virtual resource planning entity that interfaces with the Network Controller 302 and the Compute Manager 303 in the data center to collect data of the Cloud network and compute resources. Taking into account multipath connection and consolidation features of server virtualization, the Cloud Resource Planner 301 can compute optimized resource allocation plans with respect to dynamic user requests in terms of network flows and virtual machine capacity, helping a cloud operator improve performance, scalability and energy efficiency. The Cloud Resource Planner 301 module can be implemented and executed as a pluggable component to the data center middleware.

Using the network report 304 and the server report 306, sent respectively by the Network Controller 302 and Compute Manager 303 modules, the Cloud Resource Planner module 301 can compute an optimized resource allocation plan, and then sends commands 305 and 307 back to the Network Controller 302 and Compute Manager 303 in order to allocate physical resources for VMs and virtual flows.

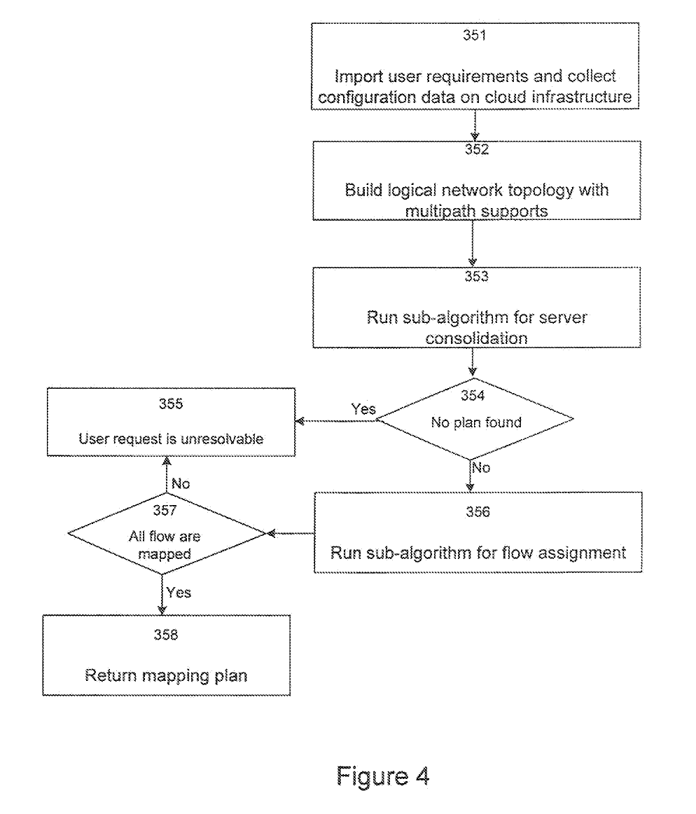

FIG. 4 illustrates a virtual resource allocation algorithm which can be implemented by a Cloud Resource Planner 301, as described herein. The process begins by receiving user requirements and configuration data (block 351). The data collection step (block 351) can include importing the user requirements and configuration data from the Network Controller 302 and Computer Manager 303 modules. In block 352, a logical topology interconnecting network nodes with multipath supports between nodes is built and established. In block 353, a server consolidation algorithm is run to allocate as many as possible VMs on each server. The server consolidation algorithm aims to minimize the number of flows between the VMs, and to reduce the number of servers required for each user request. If all of the VMs in the network topology cannot be assigned to servers, the server consolidation algorithm will fail (block 354). In such a scenario, the user request will be determined to be unresolvable (block 355).

When a plan for server consolidation is found, the process moves to block 356, where a flow assignment algorithm is run. The flow assignment algorithm aims to build an optimal plan for link allocation between the VMs assigned to servers in block 353. In block 357 it is determined if all flows have been mapped to physical links. If no, the user request is determined to be unresolvable (block 355). If yes, an optimized mapping plan has been determined and can be output (block 358).

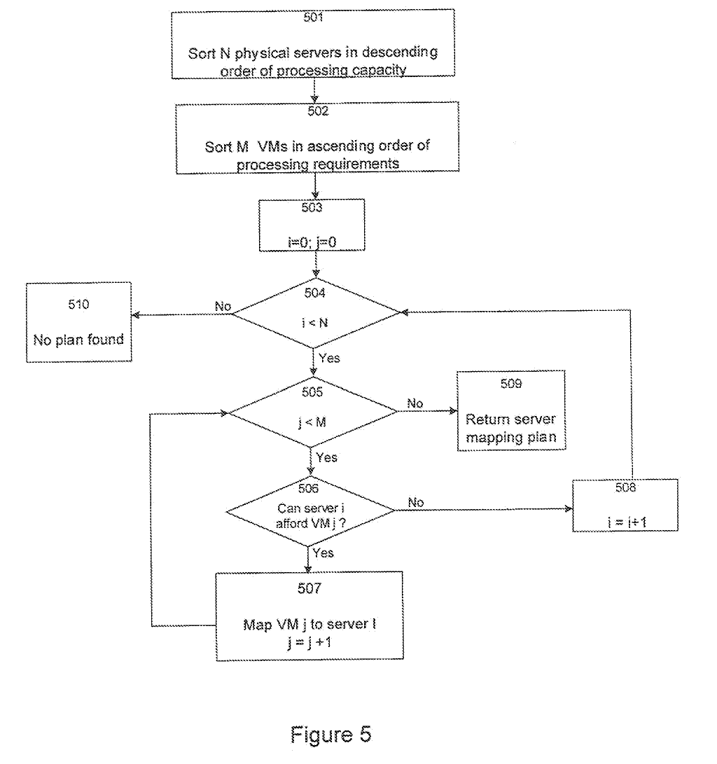

FIG. 5 illustrates an example method for server consolidation. The method of FIG. 5 can be utilized as the server consolidation algorithm 353 shown in FIG. 4. This sub-algorithm tries to maximize the consolidation of VMs into servers, hence minimizing the number of virtual flows to be mapped. Given N number of servers with available capacity (as reported by the Compute Manager module, for example) and M number of VMs to be placed on servers (as specified via a user interface), the method begins by sorting the N servers in descending order in accordance with their respective server capacity (block 501). The M VMs are sorted in ascending order of their required capacity (block 502). Two counters i, j are initialized in block 503. Counter i is used to check whether all servers are used (block 504). Counter j is used to check if all VMs are mapped (block 505).

In block 506 it is determined if server i has enough capacity to host the VM j. This can be determined by comparing the available capacity of Server i to the required capacity of VM j. If yes, a mapping of VM j to Server i will be defined (block 507), and counter j will be incremented. Otherwise, counter i will be incremented and the next server (e.g. Server i+1) in the list will be used (block 508) when the process returns to block 504. The process ends in block 509 when it is determined that all VMs are mapped (e.g. counter j=M) to a physical server. The process can also end in block 510 if no suitable mapping plan can be determined (e.g. if there is insufficient available server capacity to host all requested VMs).

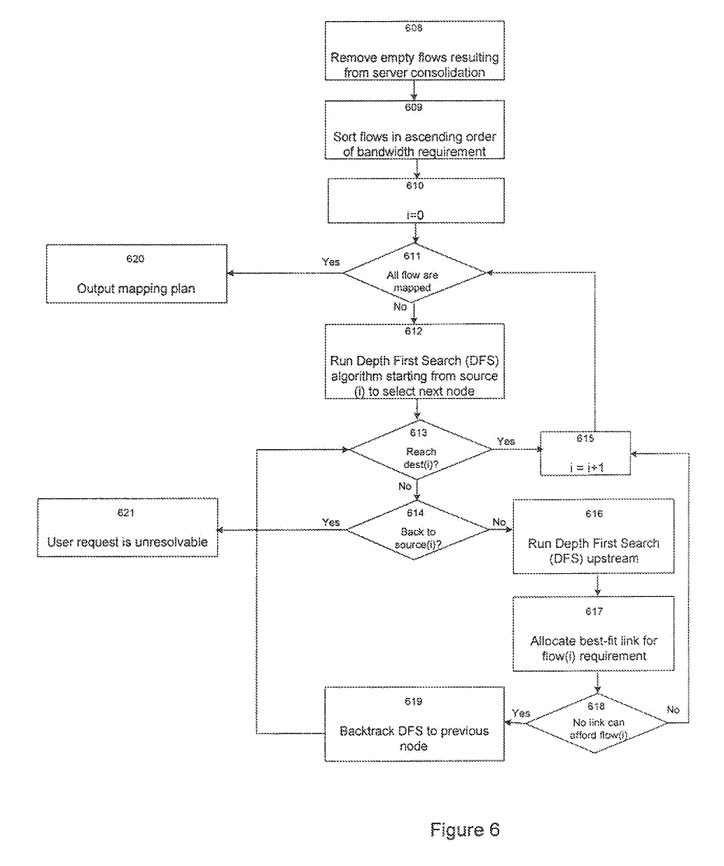

FIG. 6 illustrates an example method for flow assignment. The method of FIG. 6 can be utilized as the flow assignment algorithm 356 shown in FIG. 4. The method of FIG. 6 can be implemented following a server consolidation algorithm, placing VMs on servers, such as that of FIG. 5. The method of FIG. 6 aims to assign virtual flows (between VMs) to physical links (between physical servers). If VMs have been consolidated on the same server, all “empty” flows linking VMs which reside on the same physical servers can be removed (block 408). The remaining virtual flows will then be sorted in ascending order in accordance with their respective bandwidth requirements (block 409). A counter i is initialized (block 410) and is used to check if all flows have been mapped (block 411).

Starting from the source node of the smallest flow (e.g. the flow with the lowest bandwidth requirement, i=0), a Depth First Search (DFS) algorithm will be executed to select intermediate switches (block 412). The DFS algorithm is executed starting from the source edge switch, then goes upstream (block 416). At each intermediate node, the algorithm will try to allocate physical links with the total bandwidth capacity being best-fit to the virtual flow requirement (block 417). If the sum of the bandwidth of all of the physical links does not meet the requirement (block 418), the algorithm backtracks to the previous (e.g. upstream) node 419. This step is looped until either the destination node (block 413) or the source node (block 414) is reached. If the algorithm returns back to the source node (in block 414), the problem is unsolvable and the user request is determined to be unresolvable (block 621). If the destination node is reached (in block 413), the counter i is incremented (block 415) and the algorithm will attempt to map the next virtual flow in the list. The process continues iteratively until it is determined that all flows have been mapped (block 411) and a mapping plan for virtual flows to physical links can be output (block 420).

Those skilled in the art will appreciate that Depth First Search is an exemplary searching algorithm starting at a root node and exploring as far as possible along each branch before backtracking. Other optimization algorithms can be used for optimally mapping virtual flows to physical links without departing from the scope of the present invention. As described above, if it is determined that a single physical path does not meet the bandwidth required for a virtual flow, a multipath solution composed of multiple physical links will be allocated for the flow.

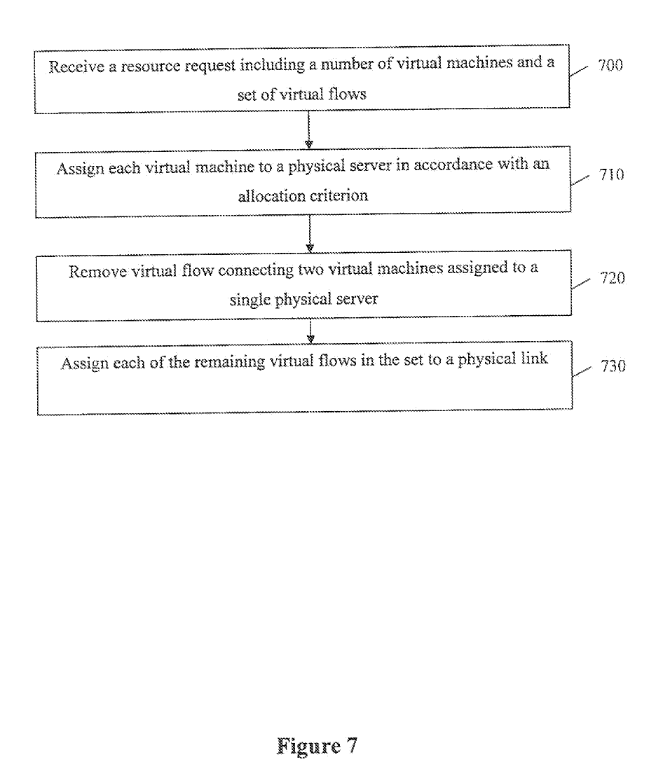

FIG. 7 is a flow chart illustrating a method for assigning virtual network elements to physical resources. The method of FIG. 7 can be implemented by a Cloud Resource Planner module or by a Data Center Management device. The method begins by receiving a resource request (block 700) including a number of VMs to be hosted and a set of virtual flows indicating a connection between two of the VMs. The resource request can include processing requirements for each of the VMs and bandwidth requirements for each of the virtual flows. Each of the VMs is assigned to a physical server, selected from a plurality of available physical servers, in accordance with at least one allocation criteria (block 710). The allocation criteria can be a parameter, an objective, and/or a constraint for placing the VMs on servers. The allocation criteria can include an objective of maximizing the consolidation of VMs into the physical servers (i e minimizing the total number of physical servers user to host the VMs in the resource request). Optionally, the allocation criteria can include an objective to minimize a number of virtual flows required to be assigned to physical links. This can be accomplished by attempting to assign any VMs connected by a virtual flow to the same physical server. Optionally, the allocation criteria can include comparing the processing requirement associated with some of the virtual machines to an available processing capacity of at least one of the physical servers to determine a best fit for the VMs in view of available processing capacity.

In an optional embodiment, block 710 can include the steps of sorting the physical servers in decreasing order according to their respective server processing capacity, and selecting a first one of the physical servers in accordance with the sorted order of physical servers. The VMs are sorted in increasing order according to their respective processing requirement, and a first one of the virtual machines is selected in accordance with the sorted order of virtual machines. The selected virtual machine is then placed on, or assigned to, the selected physical server. If it is determined that the processing requirement of the selected virtual machine is greater than the available processing capacity of the selected physical server, a second of the physical servers is selected in accordance with the sorted order of physical servers. The selected virtual machine is then assigned to the second physical server.

Following the assignment of the VMs to physical servers, a virtual flow that connect two VMs assigned to a common, single physical server can be identified and removed from the set of virtual flows (block 720). The set of virtual flows needing to be mapped to physical resources can be modified by eliminating all flows connecting VMs assigned to the same physical server. Optionally, a virtual flow that is identified and removed from the set can be added as an entry in a forwarding table in the physical server hosting the connected VMs. A virtual switch (vSwitch) can be provided in the physical server to provide communication between VMs hosted on that server. The vSwitch can include a forwarding table to enable such communication.

Each of remaining virtual flows in the modified set can then be assigned to a physical link, connecting the physical servers to which the VMs associated with the virtual flow have been assigned (block 730). A physical link can be a route composed of multiple sub-links, providing a communication path between the source physical server and destination physical server hosting the VMs.

Optionally, in block 730, it may be determined that a bandwidth requirement of a virtual flow is greater than the available bandwidth capacity of a single physical link. Such a virtual flow can be assigned to two or more physical links between the required source and destination servers in order to satisfy the requested bandwidth requirement. The physical links can encompass connection paths directly between servers, as well as connections that pass through switching elements to route communication between physical servers. A multipathing algorithm can be used to determine the two or more physical links to be assigned a virtual flow.

The modified set of virtual flows can be sorted in increasing order in accordance with their respective bandwidth capacity requirements. A first of the virtual flows can be selected in accordance with the sorted order of virtual flows. A first physical link is allocated in accordance with a source physical server and a destination physical server associated with the virtual flow. The source and destination physical servers being the servers to which the virtual machines connected by the selected virtual flow have been assigned. The first physical link can also be allocated in accordance with the bandwidth capacity requirement of the selected virtual flow. A second physical link can be allocated to meet the bandwidth capacity requirement of the selected virtual flow. Following the assignment of the first selected virtual flow to one or more physical links, a second of the virtual flows can be selected in accordance with the sorted order. The process can continue until all of the virtual flows in the modified set have been assigned to physical links.

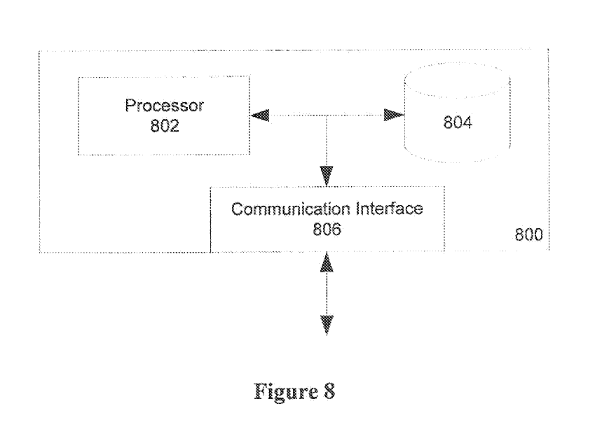

FIG. 8 is a block diagram of an example cloud management device or module 800 that can implement the various embodiments of the present invention as described herein. In some embodiments, device 800 can be a Data Center Manager 300 or alternatively a Cloud Resource Planner module 301, as were described in FIG. 3. Cloud management device 800 includes a processor 802, a memory or data repository 804, and a communication interface 806. The memory 804 contains instructions executable by the processor 802 whereby the device 800 is operative to perform the methods and processes described herein.

The communication interface 806 is configured to send and receive messages. The communication interface 806 receives a request for virtualized resources, including a plurality of VMs and a set of virtual flows indicating a connection between two of the VMs in the plurality. The communication interface 806 can also receive a list of a plurality of physical servers and physical links connecting the physical servers which are available for hosting the virtualized resources. The processor 802 assigns each VM in the plurality to a physical server selected from the plurality of servers in accordance with an allocation criterion. The processor 802 modifies the set of virtual flows to remove any virtual flows linking two VMs which have been assigned to a single physical server. The processor 802 assigns each of the virtual flows in the modified set to a physical link. The processor 802 may determine that a bandwidth of a requested virtual flow is greater than the available bandwidth capacity of any physical link. The processor 802 can assign the virtual flow to multiple physical links to meet the bandwidth requested. When all requested virtual resources have been assigned, the communication interface 806 can transmit a mapping of the virtual resources to their assigned physical resources.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for assigning virtual network elements to physical resources comprising:
receiving a resource request including a plurality of virtual machines and a set of virtual flows, each of the virtual flows connecting two virtual machines in the plurality;
assigning each virtual machine in the plurality of virtual machines to a physical server in a plurality of physical servers in accordance with an allocation criteria;
modifying the set of virtual flows to remove a virtual flow connecting two virtual machines assigned to a single physical server; and
assigning each of the virtual flows in the modified set to a physical link.

2. The method of claim 1, wherein the allocation criteria includes maximizing a consolidation of virtual machines into physical servers.

3. The method of claim 1, wherein the allocation criteria includes minimizing a number of virtual flows required to be assigned to physical links.

4. The method of claim 1, wherein the allocation criteria includes comparing a processing requirement associated with at least one of the plurality of virtual machines to an available processing capacity of at least one of the plurality of physical servers.

5. The method of claim 1, wherein assigning each virtual machine in the plurality of virtual machines to a physical server in the plurality of physical servers includes:
sorting the physical servers in decreasing order according to server processing capacity; and
selecting one of the physical servers in accordance with the sorted order of physical servers.

6. The method of claim 5, further comprising:
sorting the virtual machines in increasing order according to virtual machine processing requirement;
selecting one of the virtual machines, in accordance with the sorted order of virtual machines; and
placing the selected virtual machine on the selected physical server.

7. The method of claim 6, further comprising:
responsive to determining that a processing requirement of the selected virtual machine is greater than an available processing capacity of the selected physical server, selecting a second of the physical servers in accordance with the sorted order of physical servers; and
placing the selected virtual machine on the second physical server.

8. The method of claim 1, wherein the removed virtual flow is assigned an entry in a forwarding table in the single physical server.

9. The method of claim 1, wherein, responsive to determining that a bandwidth capacity of a virtual flow is greater than an available bandwidth capacity of a physical link, assigning the virtual flow to multiple physical links.

10. The method of claim 9, wherein the multiple physical links are allocated in accordance with a source physical server, a destination physical server, and the bandwidth capacity associated with the virtual flow.

11. A cloud management device comprising a communication interface, a processor, and a memory, the memory containing instructions executable by the processor whereby the cloud management device is operative to:
receive a resource request, at the communication interface, including a plurality of virtual machines and a set of virtual flows, each of the virtual flows connecting two virtual machines in the plurality;
assign each virtual machine in the plurality of virtual machines to a physical server in a plurality of physical servers in accordance with an allocation criteria;
modify the set of virtual flows to remove a virtual flow connecting two virtual machines assigned to a single physical server; and
assign each of the virtual flows in the modified set to a physical link.

12. The cloud management device of claim 11, further comprising, transmitting, at the communication interface, a mapping of the virtual machines and the virtual flows to their assigned physical resources.

13. The cloud management device of claim 11, wherein the allocation criteria includes maximizing a consolidation of virtual machines into physical servers.

14. The cloud management device of claim 11, wherein the allocation criteria includes minimizing a number of virtual flows required to be assigned to physical links.

15. The cloud management device of claim 11, wherein the allocation criteria includes comparing a processing requirement associated with at least one of the plurality of virtual machines to an available processing capacity of at least one of the plurality of physical servers.

16. The cloud management device of claim 11, wherein the cloud management device is further operative to:
sort the physical servers in decreasing order according to server processing capacity; and
select one of the physical servers in accordance with the sorted order of physical servers.

17. The cloud management device of claim 16, wherein the cloud management device is further operative to:
sort the virtual machines in increasing order according to virtual machine processing requirement;
select one of the virtual machines, in accordance with the sorted order of virtual machines; and
place the selected virtual machine on the selected physical server.

18. The cloud management device of claim 17, wherein the cloud management device is further operative to:
responsive to determining that a processing requirement of the selected virtual machine is greater than an available processing capacity of the selected physical server, select a second of the physical servers in accordance with the sorted order of physical servers; and
place the selected virtual machine on the second physical server.

19. The cloud management device of claim 11, wherein the removed virtual flow is assigned an entry in a forwarding table in the single physical server.

20. The cloud management device of claim 11, wherein the cloud management device is further operative to, responsive to determining that a bandwidth capacity of a virtual flow is greater than an available bandwidth capacity of a physical link, assign the virtual flow to multiple physical links.

21. The cloud management device of claim 20, wherein the multiple physical links are allocated in accordance with a source physical server, a destination physical server, and the bandwidth capacity associated with the virtual flow.

22. A data center manager comprising:
a compute manager module for monitoring server capacity of a plurality of physical servers;
a network controller module for monitoring bandwidth capacity of a plurality of physical links interconnecting the plurality of physical servers; and
a resource planner module for receiving a resource request indicating a plurality of virtual machines and a set of virtual flows; for instructing the compute manager module to instantiate each virtual machine in the plurality of virtual machines to a physical server in the plurality of physical servers in accordance with an allocation criteria; for modifying the set of virtual flows to remove a virtual flow connecting two virtual machines assigned to a single physical server; and for instructing the network controller module to assign each of the virtual flows in the modified set to a physical link in the plurality of physical links.
